(19) United States
(12) Patent Application Publication
(10) Pub. No.: US 2007/0113798 A1
(43) Pub. Date: May 24, 2007

(54) Animal assistance sling and related methods for assisting animals

(76) Inventor: Shaleen Torjesen, Plymouth, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/603,559

(22) Filed: Nov. 22, 2006

Related U.S. Application Data
(60) Provisional application No. 60/739,851, filed on Nov. 23, 2005.

(51) Int. Cl. A61D 3/00

(52) U.S. Cl. 119/725

(57) ABSTRACT

Apparatus and related methods for assisting and supporting animals by providing a support assembly for assisting in the transport of animals during recovery from surgery or due to old age or other maladies. The support assembly can include a support sling and a strap assembly wherein the support sling wraps about a lower portion of the animal and the strap assembly provides a grip arrangement for a user to lift the support sling, thereby supporting the animal. The support sling can include both a support material and a removable sling diaper. The support sling can be retainably attached around the animal's body even when the support assembly is not in use. The strap assembly can be removably attached to the support sling so as not to bother the animal when the support assembly is not being used by the owner.

### PRIORITY CLAIM

The present application claims priority to U. S. Provisional Application Ser. No. 60/739,851, filed Nov. 23, 2005, and entitled “ANIMAL ASSISTANCE SLING AND RELATED METHODS FOR ASSISTING ANIMALS”, which is herein incorporated by reference in its entirety.

### FIELD OF THE INVENTION

The present invention relates generally to devices for assisting animals suffering from maladies effecting their ability to walk and/or support themselves. More particularly, the invention relates to an animal assistance sling for quick and convenient attachment to a pet therefore allowing a pet owner to comfortably support the weight of their pet.

### BACKGROUND OF THE INVENTION

Recent advances in medical technologies and procedures have not only benefited human beings but have allowed pet owners to seek treatment for their pets that was not available in the past. For instance, treatment regimens now exist for the treatment of dogs suffering from maladies such as, for example, arthritis and hip dysplasia. In addition, many dogs can suffer from the common effects of old age where muscles and joints can become painful leading to a loss of mobility.

A number of patents describe devices for assisting in lifting animals for treatment and transport. Representative patents included U.S. Pat. Nos. 4,489,677; 4,537,154; 4,550,686; 4,559,906; 4,644,902; and 4,831,976, all of which are herein incorporated by reference in their entirety. In addition to the aforementioned patents, a number of patents refer to devices specifically targeted to the assistance of walking and/or transporting animals that either lack the strength or stamina to support themselves. For instance, dog assist harnesses for dogs with crippled hindquarters or following surgery are described in U.S. Pat. Nos. 6,216,636 and 6,694,921, both of which are herein incorporated by reference in their entirety.

While the need for supporting and assisting animals as part of treatment recovery or due to age or illness has been recognized, there remains a need to further improve the convenience and ease of use of such support devices.

### SUMMARY OF THE INVENTION

The present invention addresses the aforementioned needs of improving the convenience and ease of use associated with assisting and supporting animals by providing an animal support assembly for assisting in the transport and/or walking of animals during recovery from surgery or due to old age or other maladies. The animal support assembly generally comprises a support sling and a strap assembly wherein the support sling wraps about a lower portion of the animal and the strap assembly provides a grip arrangement for a user to lift the support sling, thereby supporting the animal. In some representative embodiments, the support sling can comprise a support material and a removable sling diaper. The removable sling diaper serves to maintain the cleanliness of the support material. The removable sling diaper can comprise laundry-suitable materials or can comprise a disposable diaper. The support sling can be retainably attached around the animal's body such that a user not be required to lift or manipulate an animal each time the support assembly is used. The strap assembly can be removably attached to the support sling so as not to bother the animal when the support sling is retained around the animal and the support assembly is not being used by the owner. The support sling can comprise pockets for convenient retention of material such as, for example, veterinary records and the like.

In one aspect, a representative embodiment of a support assembly of the present invention comprises a sling assembly and a strap assembly. The sling assembly generally wraps about a lower portion of the animal while the strap assembly provides a grip arrangement to a user for lifting the support sling. The sling assembly preferably comprises a removable diaper that is in contact with the animal to absorb any waste products so as to maintain the cleanliness of both the animal and the sling assembly. The support sling can comprise external features including aesthetic features and pockets for convenient retention of material such as, for example, veterinary records and the like.

In another aspect, the present invention relates to a method of supporting an animal during transportation or walking. First, a sling assembly can be positioned around the animal's belly at a location proximate the animal's hind legs. Next, a retaining assembly such as, for example, as strap or sheet can be wrapped over the top of the animal such that the sling assembly fully surrounds four sides of the animal. A strap assembly can then be attached to the sling assembly by attaching strap connectors to corresponding adapters on the sling assembly. A user can then lift up on the strap assembly to provide support and assistance to the animal by reducing the load on the animal's hind legs. The method can further comprise attaching a clean diaper to the sling assembly so as to accommodate the animal's waste products. In addition, the sling assembly and strap assembly can be attached to a collar assembly so as provide additional control of the animal.

In another aspect, the present invention relates to an animal support and collar assembly. The animal support and collar assembly can include a support assembly operably connected to a collar assembly. With the animal support and collar assembly, a user can simultaneously support and control movement of the animal through a single strap assembly.

The above summary of the various representative embodiments of the invention is not intended to describe each illustrated embodiment or every implementation of the invention. Rather, the embodiments are chosen and described so that others skilled in the art may appreciate and understand the principles and practices of the invention. The figures in the detailed description that follows more particularly exemplify these embodiments.

### BRIEF DESCRIPTION OF THE DRAWINGS

The invention may be more completely understood in consideration of the following detailed description of various embodiments of the invention in connection with the accompanying drawings, in which:

FIG. 1 is a plan view of an embodiment of an animal support assembly of the present disclosure;

FIG. 2 is an exploded plan view of a sling assembly for use with the animal support assembly of FIG. 1;

FIG. 3 is a perspective view of the animal support assembly of FIG. 1;

FIG. 4 is a perspective view of the animal support assembly of FIG. 1;

FIG. 5 is a perspective view of the animal support assembly of FIG. 1 in use to support an animal;

FIG. 6 is an enlarged perspective view of the animal support assembly of FIG. 1 is use to support an animal;

FIG. 7 is a perspective view of an embodiment of an animal support assembly of the present disclosure;

FIG. 8 is a perspective view of the animal support assembly of FIG. 7 in use to support an animal;

FIG. 9 is a plan view of an embodiment of an animal support assembly of the present disclosure;

FIG. 10 is a plan view of an embodiment of an animal support assembly of the present disclosure;

FIG. 11 is a perspective view of an embodiment of an animal support and collar assembly of the present disclosure being used to support and restrain an animal;

FIG. 12 is a perspective view of the animal support and collar assembly of FIG. 11 being used to support and restrain an animal;

FIG. 13 is a perspective view of the animal support and collar assembly of FIG. 11 being used to support and restrain an animal; and

FIG. 14 is a perspective view of the animal support and collar assembly of FIG. 11 being used to support and restrain an animal.

While the invention is amenable to various modifications and alternative forms, specifics thereof have been shown by way of example in the figures and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

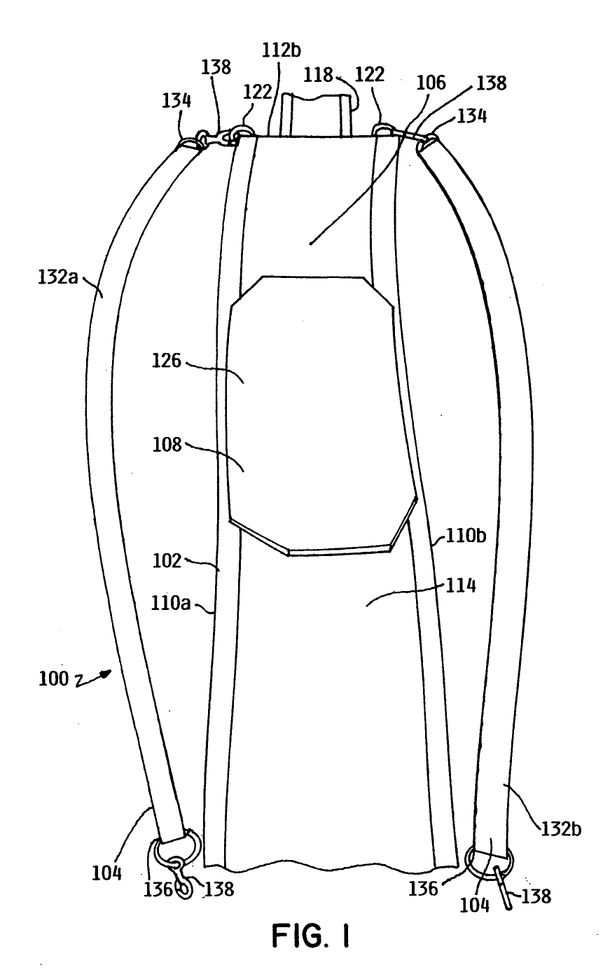

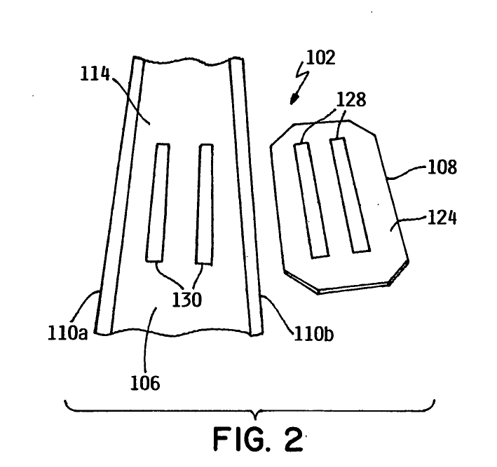

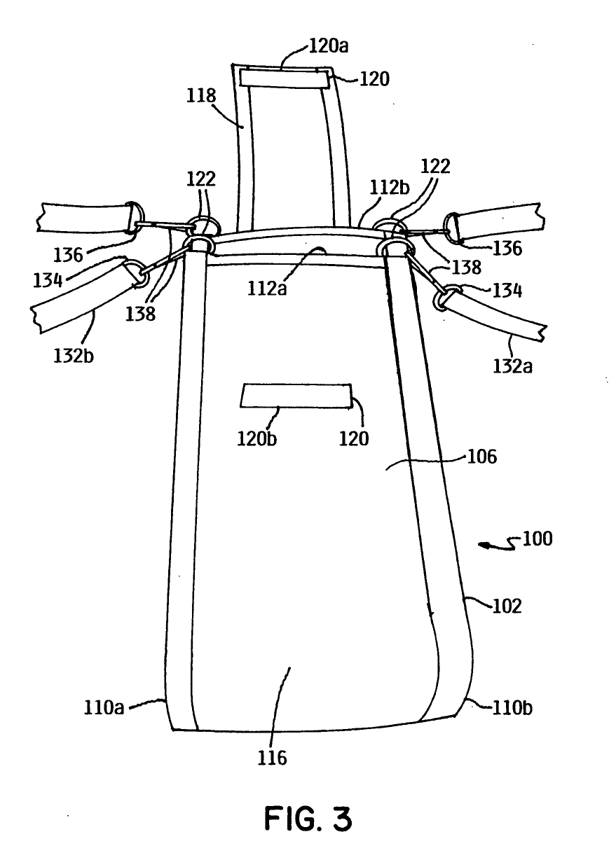

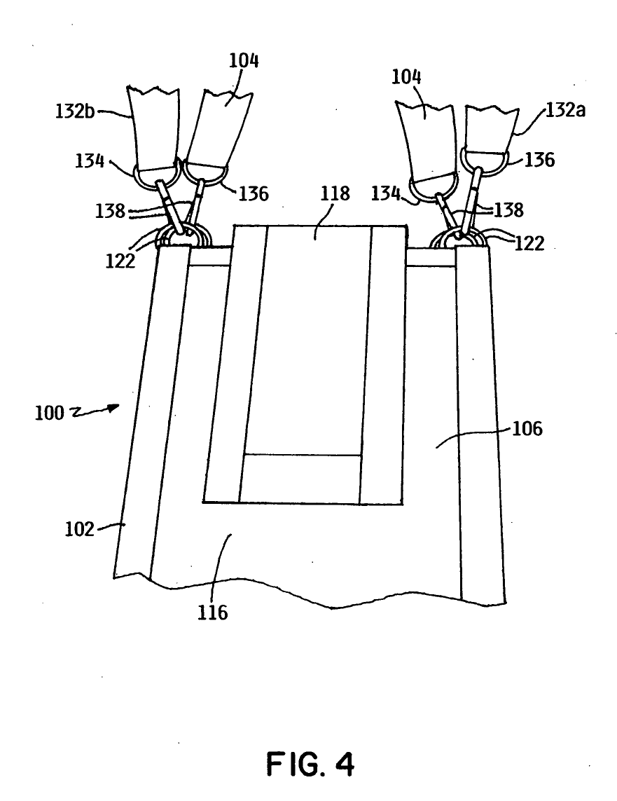

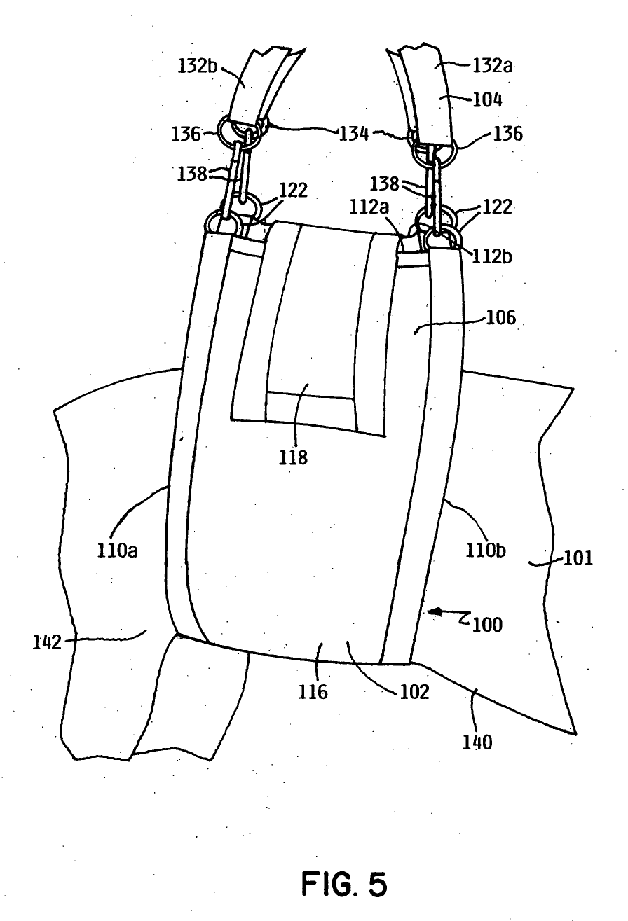

As illustrated in FIGS. 1, 2, 3, 4, 5 and 6, an embodiment of an animal support assembly 100 for use in supporting an animal 101 can comprise a sling assembly 102 and a strap assembly 104. Sling assembly 102 can comprise a support sheet 106 and a detachable diaper sheet 108. Support sheet 106 is generally defined by a pair of first sheet sides 110a, 110b, a pair of second sheet sides 112a, 112b, an animal contact surface 114 and an externally visible surface 116. Support sheet 108 can further comprise a retaining sheet 118 generally attached proximate the second sheet side 112a. Retaining sheet 118 can comprise a retainer assembly 120 comprised of a first retainer 120a on the retaining sheet 118 and a second retainer 120b attached near the second sheet side 112a. A strap adapter 122 can be attached at each of the four corners of support sheet 108.

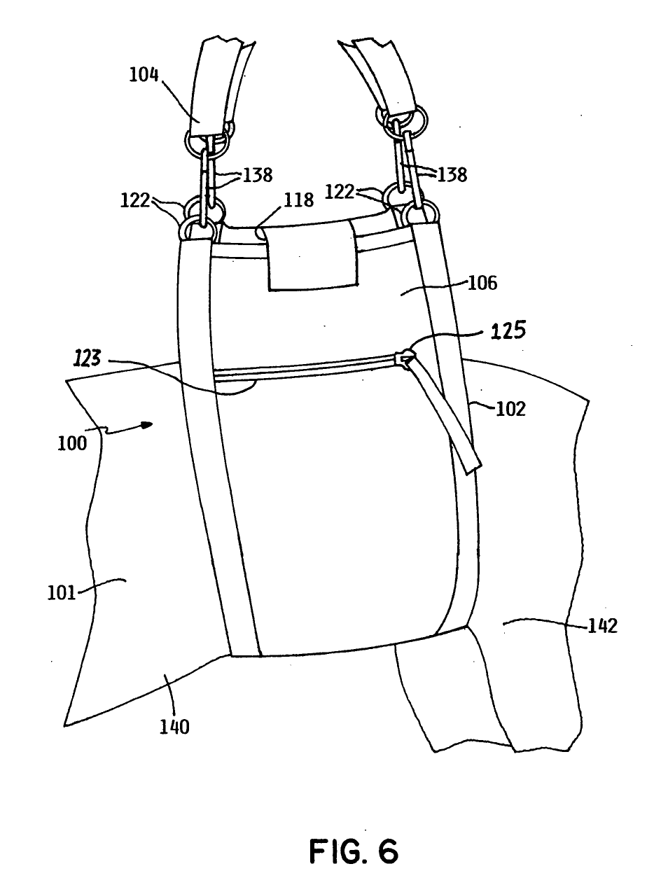

Support sheet 106 can comprise materials of construction that are preferably comfortable to the animal, provide sufficient strength to lift the animal are machine washable for maintaining cleanliness and hygiene of the animal support assembly 100. Representative materials for support sheet 108 can comprise natural fabrics such as, for example, cotton, wool, and leather or alternatively, synthetic fabrics such as rayon and nylon. Support sheet 106 can be fabricated to include an accessible pocket 123 having a closure feature such as, for example, zipper 125 or other similar closure features as illustrated in FIG. 6.

Detachable diaper sheet 108 generally comprises an attachment surface 124 and an absorbent surface 126. Preferably, detachable diaper sheet 108 comprises an absorbent interior for absorbing waste products such as urine from the animal 101. Detachable diaper sheet 108 can comprise similar materials of construction as support sheet 106 or alternatively, detachable diaper sheet can comprise paper and/or plastic materials providing for easy disposal of the detachable diaper sheet 108 upon soiling. A disposable, detachable diaper sheet can be constructed in a similar fashion as adult and children's diapers sold under the trade names Depends™, Huggies™, Pampers™ and Luvs™. Attachment surface 124 can comprise a diaper attachment member 128 for fixedly attaching the detachable diaper sheet 108 to a diaper support attachment member 130 on the animal contact surface 114 of the support sheet 106.

Strap assembly 104 can comprise a pair of straps 132a, 132b. Straps 132a, 132b can comprise similar materials of construction as used with sling assembly 102. Each strap 132a, 132b comprises a first end 134 and a second end 136 with each end having a strap connector 138. Strap connector 138 is generally configured for detachable connection to the strap adapters 122 on the sling assembly 102.

In use, animal support assembly 100 can be used to support an animal 101 requiring assistance due to a recent surgery or malady such as, for example, old age. First, the detachable diaper assembly 108 is coupled to the support sheet 108 by attaching diaper attachment member 128 with the diaper support attachment member 130. Next, sling assembly 102 is positioned below an animal belly 140 proximate an animal's hind legs 142. Sling assembly 102 is positioned such that animal contact surface 114, and correspondingly the absorbent surface 126 of detachable diaper sheet 108, is in physical contact with animal 101. Then, the second sheet sides 112a, 112b are pulled around the animal body 142 such that sling assembly is positioned generally around the bottom and side portions of animal 101. Finally, retaining sheet 118 is wrapped over the top of animal 101 such that the first retainer 120a is connected to the second retainer 120b wherein the sling assembly 102 fully surrounds four sides of the animal body 142.

Next, strap assembly 104 is attached to the sling assembly 102 by attaching the each of the strap connectors 138 to one of the strap adapters 122. Strap connectors 138 can be attached to any of the strap adapters 122 to provide a desired gripping rotation of the strap 132a, 132b to the user. Once strap assembly 104 is operably attached to the sling assembly 102, a user can lift up on the straps 132a, 132b to provide support and assistance to the animal 101 by reducing the load on hind legs 142.

When in use, animal 101 may involuntary soil the detachable diaper sheet 108. Depending upon its configuration, detachable diaper sheet 108 can be separated from the support sheet 108 for machine washing and reuse or may simply be discarded. In addition, strap assembly 104 can be detached from the sling assembly 102 such that the sling assembly 102, and more specifically, the detachable diaper sheet 108 remains in physical contact with animal 101 even when animal support assembly 100 is not being used to support animal 101.

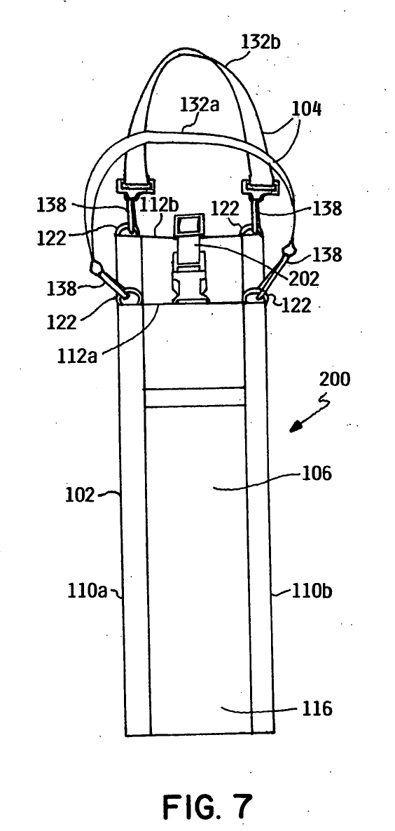

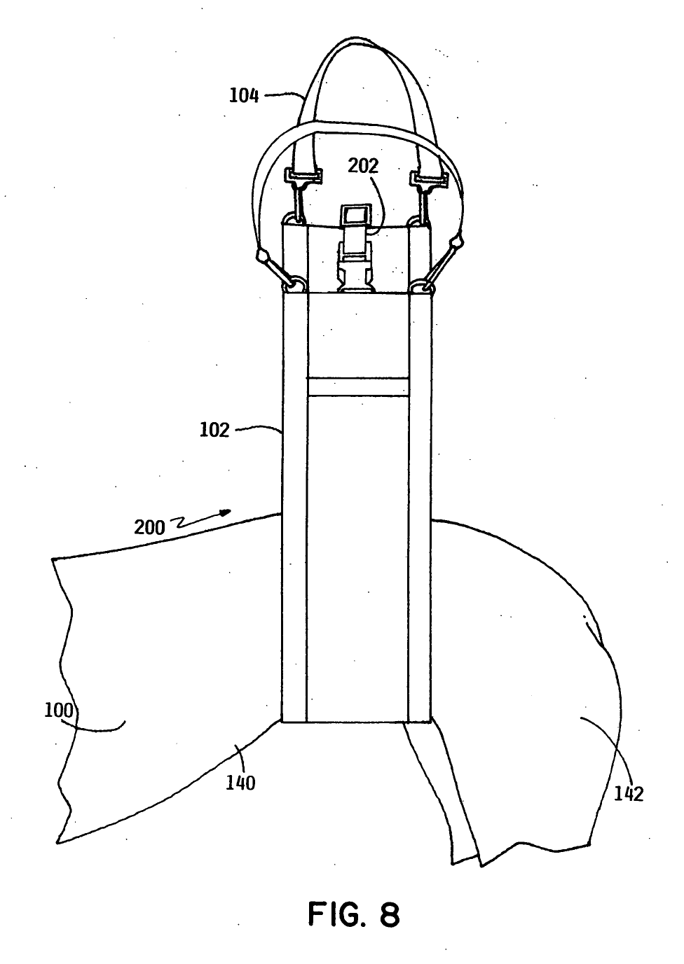

As will be understood by one of skill in the art, the animal support assembly can be provided in a variety of alternative configurations intended to increase ease of use and/or aesthetic qualities. For example, another representative embodiment of an animal support assembly 200 can substantially resemble animal support assembly 100 with a quick-connect retaining strap 202 in place of retaining sheet 118 as illustrated in FIGS. 7 and 8. Quick-connect restraining strap 202 can include a variety of quick-connect designs providing a locking style closure.

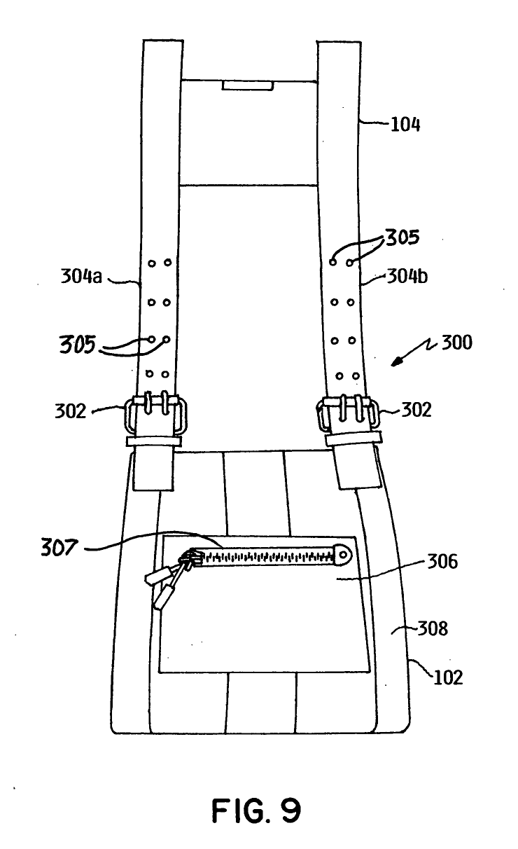

Referring to FIG. 9, another representative embodiment of an animal support assembly 300 can similarly resemble animal support assemblies 100 and 200 with the further inclusion of a buckle assembly 302 allowing a user the ability to selectively adjust the length of attaching straps 304a, 304b. Depending upon the size of the animal, a user can adjust the holding length of attaching straps 304a, 304b by positioning the buckle assembly 302 in any of a plurality of spaced apart strap apertures 305. Animal support assembly 300 can further comprise a pocket 306 having a closure member 307 on the externally visible surface 308 for storing items such as, for example, veterinary records and the like.

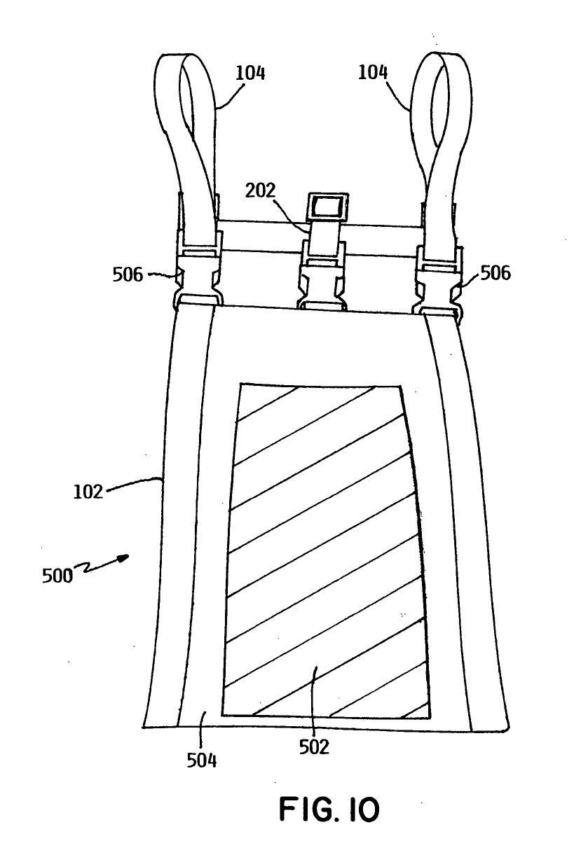

As illustrated in FIG. 10, another representative embodiment of an animal support assembly 500 can comprise an exterior design element 502 on an externally visible surface 504. Exterior design element 502 can be selected to provide a desired aesthetic appearance and may include designs or text such as, for example, the animals name. In addition, exterior design element 502 can be detachably connected to externally visible surface 504 with suitable connectors such as, for example, a hook and loop fastener or snap style fastener allowing a user to selectively replace the exterior design element 502 with a second design element having an alternative appearance.

With reference to the previously discloses embodiments for an animal support assembly, it is to be understood that suitable designs, colors and fabrics can be used to individualize and/or personalize the appearance of the various animal support assemblies. It will be further understood that the strap and support body can be detachably connected using any of a variety of suitable connecting elements including slidable snap connectors 506, buckle assembly 302, buttons, hook and loop fasteners, snaps and the like.

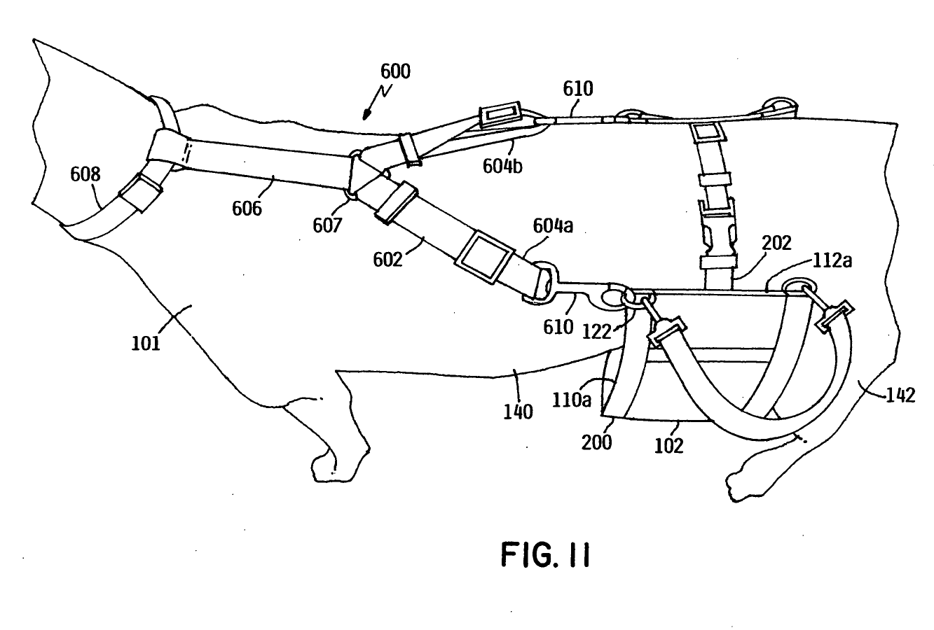

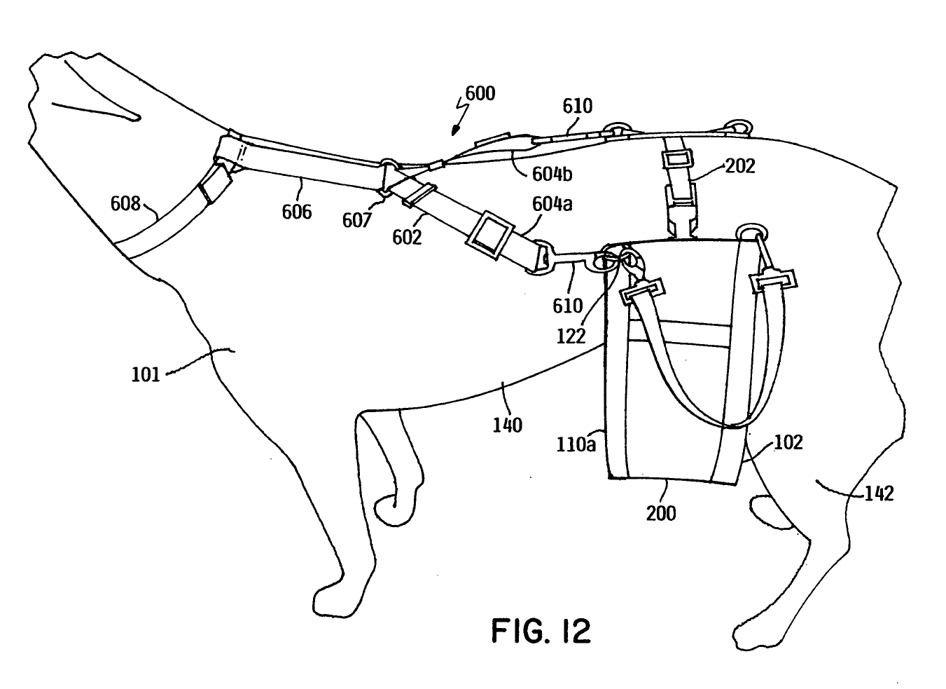

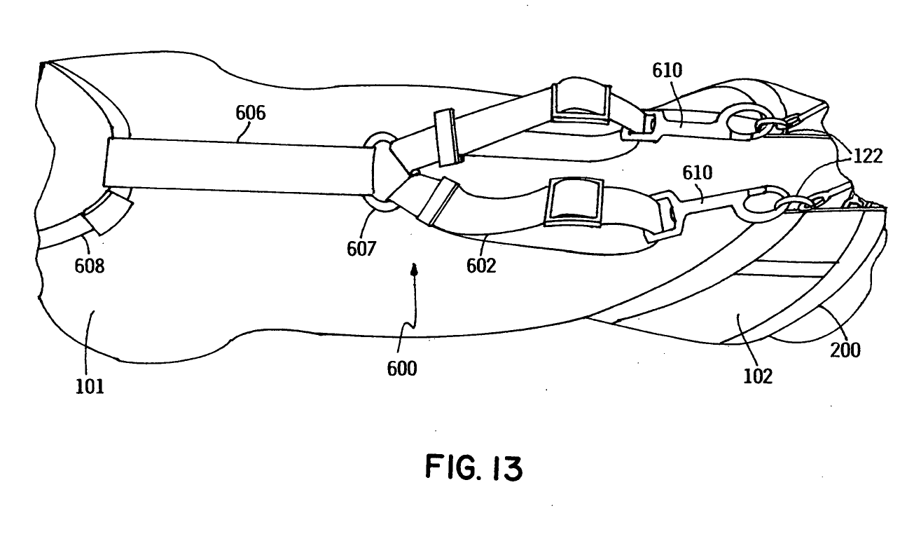

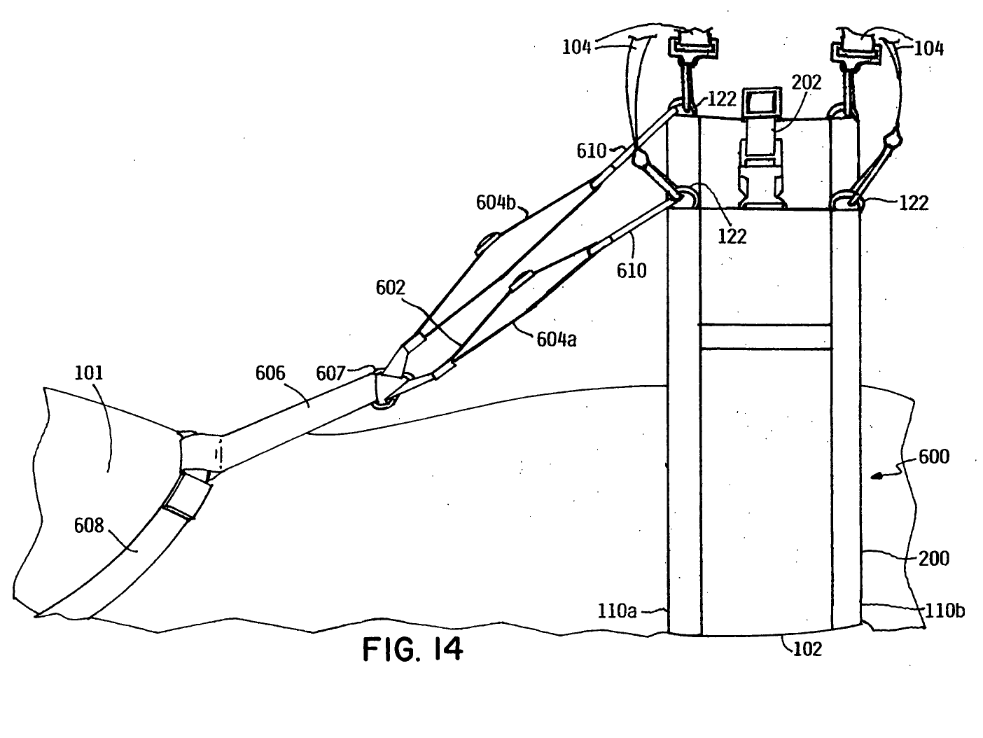

As illustrated in FIGS. 11, 12, 13 and 14, the previously disclosed animal support assemblies including animal support assembly 200 can be used in conjunction with a collar harness 602 to form an animal support and collar assembly 600. Collar harness 602 can comprise a pair of support connecting straps 604a, 604b, a collar connecting strap 606, a strap receiver 607 and a collar 608. Collar 608 can comprise a standard dog collar having collar connecting strap 606 permanently attached. Alternatively, connecting strap 606 can comprise a collar attachment member for using the collar harness 602 with any standard, conventional dog collar. Support connecting straps 604a, 604b each include a support attachment member 610 for detachably joining the support connecting straps 604a, 604b to the strap adapters 122 on first sheet side 110a.

Animal support and collar assembly 600 is used with animal 101 by attaching animal support assembly 200 in a similar manner as that previously described with respect to animal support assembly 100. Next, collar 608 is positioned and fastened about the neck of animal 101. Finally, support connecting straps 604a, 604b are attached to the animal support assembly 200 by interconnecting the support attachment members 610 to the strap adapters 122 on first side sheet 110. In this manner, a user can both support animal 101 during movement of the animal as well as control and direct the animal 101 similar to how a conventional leash is utilized.

Although the present invention has been described with respect to a representative, presently contemplated embodiment, it will be understood that numerous insubstantial changes in configuration, arrangement or appearance of the elements of the present invention can be made without departing from the intended scope of the present invention. Accordingly, it is intended that the scope of the present invention be determined by the claims as set forth.

What is claimed is:

1. An animal support assembly comprising:
a sling assembly having a support sheet and a selectively removable diaper, the support sheet having a visible external surface, an animal contact surface and a pair of end surfaces wherein each end surface includes at least two strap adapters, wherein the selectively removable diaper is attached to the animal contact surface; and
a strap assembly having at least a pair of straps wherein each strap includes a first strap end and a second strap end with a strap connector located at each strap end such that each strap is couplable to one of the end surfaces by connecting each strap connector to a strap adapter.

2. The animal support assembly of claim 1, wherein the selectively removable diaper includes a diaper attachment surface and a diaper absorbent surface, wherein the diaper attachment surface includes a diaper attachment member that removably attaches to a support sheet attachment member on the animal contact surface.

3. The animal support assembly of claim 2, wherein the diaper attachment member and the support sheet attachment member define an attachment assembly selected from the group comprising: a hook and loop attachment assembly and a snap attachment assembly.

4. The animal support assembly of claim 1, wherein the selectively removable diaper comprises a disposable diaper.

5. The animal support assembly of claim 1, wherein the strap adapters and the strap connectors define a strap attachment assembly selected from the group comprising: a buckle assembly, a button assembly, a snap assembly, a clip assembly and a hook and look assembly.

6. The animal support assembly of claim 1, wherein the sling assembly further comprises a retaining sheet permanently attached proximate one of the end surface and being removably attachable to other end surface for retainably positioning the sling assembly around an animal body.

7. The animal support assembly of claim 1, wherein the sling assembly further comprises a pocket assembly positioned on the visible external surface.

8. The animal support assembly of claim 1, further comprising:
a collar harness having a collar and a collar strap assembly, wherein the collar strap assembly operably couples the collar harness with the strap assembly such that the strap assembly provide both support to the animal body and control of the animal's movement.

9. A method for supporting an animal during movement of the animal comprising:
positioning a sling assembly around an animal such that a selectively removable diaper is arranged to capture liquid waste;
attaching a strap assembly to a pair of end surfaces on the sling assembly; and
lifting the strap assembly such that sling assembly provides a supporting force to the animal.

10. The method of claim 9, further comprising:
removing the selectively removable diaper after the selectively removable diaper has become soiled by the animal.

11. The method of claim 10, further comprising:
replacing the soiled, selectively removable diaper with a clean, selectively removable diaper.

12. The method of claim 11, wherein both the soiled and clean, selectively removable diapers comprise disposable diapers.

13. The method of claim 9, further comprising:
positioning a collar around a neck area of the animal; and
coupling the collar with the strap assembly using a collar strap assembly;
controlling the animal's movement with the strap assembly while simultaneously providing support to the animal body.

14. The method of claim 9, further comprising:
retaining the sling assembly around the animal by joining the end surfaces of the sling assembly with a retainer assembly.

15. The method of claim 14, further comprising:
detaching the strap assembly from the sling assembly when the animal requires no support assistance such that the sling assembly remains retained in position around the animal.

16. The method of claim 9, further comprising:
storing veterinary records of the animal within a pocket on a visible exterior surface of the sling assembly.

17. An animal support assembly and collar assembly for simultaneously supporting and controlling an animal comprising:
a sling assembly having a support sheet positionable about an animal, the support sheet including a retaining member and a plurality of strap adapters, the retaining member fixedly retaining the sling assembly around the animal;
a strap assembly having at least a pair of straps wherein each strap includes a first strap end and a second strap end with a strap connector located at each strap end such that each strap is couplable to the strap adapters; and
a collar assembly having a neck collar and a collar harness, the neck collar being attachable around the animal's neck while the collar harness attaches to the strap adapters,
wherein lifting the pair of straps provides control of the animal through the neck collar and the support sheet.

18. The animal support assembly of claim 17, wherein the support sheet includes a removable diaper positioned to capture waste products from the animal.
